(19) United States
(12) Patent Application Publication
(10) Pub. No.: US 2004/0016467 A1
(43) Pub. Date: Jan. 29, 2004

(54) Method of forming repair material for conuit interface area and for repairing a non-linear conduit with a fiber repair material

(76) Inventors: Mark D. Blackmore, Houston, TX (US); Mark T. Sloan, Spring, TX (US); William M. Lepola, Magnolia, TX (US)

Correspondence Address: RICHARD C. HIMELHOCH, 311 S. WACKER DRIVE, 53RD FLOOR, CHICAGO, IL, 60606-6622, US

(21) Appl. No.: 10/258,294

(22) PCT Filed: Apr. 24, 2001
(86) PCT No.: PCT/US01/13245

(51) Int. Cl. F16L 55/16

(52) U.S. Cl. 138/99; 264/36.16; 285/21.1; 285/294.1

(57) ABSTRACT

The present invention provides a method for producing a repair material for use in repairing an interface area between two intersecting conduits. According to one aspect of the invention, a mold is provided having similar dimensions to an interface area. The interface area is defined by a first conduit and a flange connecting the first conduit to a second conduit. A repair material is provided having a material structure, the material structure defined by an arrangement of fibers such that the material structure has similar dimensions to the interface area. The arrangement of fibers further allowing the repair material to be flexible and seamless. A resin is provided, the resin having a resin viscosity. An additive is provided, the additive is adapted to increase the resin viscosity. The additive is mixed with the resin to form a resin-additive mixture whereby the resin viscosity is increased after a time delay. The repair material is placed in intimate contact with the mold such a mold surface supports the repair material. The resin-additive mixture is introduced into the repair material. A sufficient amount of time elapses for the resin-additive mixture to permeate the repair material such that the resin-additive mixture adheres to the fibers thereby stabilizing the resin-additive mixture and the fibers. After the resin-additive mixture has fully adhered to and secured the fibers, the repair material is removed from the mold.

The present invention also provides a method of repairing a damaged section of a non-linear conduit, comprising a number of steps. A repair material is provided with a material structure adapted to engage an interior surface of a non-linear conduit. The material structure is defined by a plurality of fibers such that the repair material is flexible and seamless. A curable resin is introduced into the repair material by either injection or infusion depending on the type of resin utilized. Next, the repair material is placed in the conduit in close proximity to a damaged portion of the conduit. The resin is then cured. Preferably, the material structure is substantially cylindrical to facilitate conformity with the non-linear conduit. However, the material structure is flexible and can be formed by braiding, knitting, stitch-bonding, or needle-punching the fibers. Repair materials fabricated from any of these techniques offer exceptional ability to conform to irregular conduit geometries. The fibers can be electrically conductive fibers, for example carbon fibers, and in order to cure the resin, an electric current can be caused to flow through the conductive fibers to resistively heat the repair material. Alternatively, the fibers can be a combination of electrically conductive fibers and non-conductive fibers.

### RELATED CASES

The present invention claims priority from U.S. provisional application Nos. 60/199,234 and 60/199,783.

### TECHNICAL FIELD

This invention pertains to the repair of an interface between a first conduit and a second conduit. More particularly, this invention pertains to the use and fabrication of resin impregnated repair materials for repairing an interface between a first conduit and a second conduit.

This invention also pertains to the repair of non-linear conduits. More particularly, this invention pertains to the use of flexible repair materials formed from fibers for the repair of non-linear conduits.

### BACKGROUND OF THE INVENTION

As a result of the requirements of the Clean Water Act, numerous approaches have been introduced over the past twenty-five years to repair damaged underground conduits. Conduits are often referred to as sewage pipes, and include both the main and the lateral which leads to the main. Among the many approaches is cured-in-place pipe lining. Generally, the cured-in-place pipe lining (“CIPP”) approach includes placing a repair material in the conduit and curing the repair material at the location of the damage. The repair material can be cured in a number of different ways, including using steam, hot water, or applying an electric current to resistively heat the repair material.

The CIPP approach is not limited to the repair of either main or lateral conduits. For example, the CIPP approach can be used to repair a rupture in a lateral conduit near the interface area with a main conduit. In this situation, an extra segment of repair material corresponding to a flange is sewn to the lateral repair material. Although the flange segment is fastened to the lateral segment, the resulting seam represents a weakened area in the repair material.

In most CIPP applications, a curable resin is introduced into the repair material. For both ambient curable resins and heat curable resins, the resin changes phase and bonds to fibers in the repair material. Resin can be introduced into the repair material in a number of ways, including pouring the resin onto the repair material and manually distributing the resin throughout the repair material with a brush or roller. Although this approach to resin introduction is simple, this approach ensures neither precise nor consistent resin introduction. When the resin is not properly introduced into the repair material, the strength of the cured repair material is reduced.

The strength of the cured repair material is further reduced by resin redistribution. Resin redistribution occurs when gravitational forces cause the resin to move or flow from locations in the repair material. Resin redistribution can occur while resin impregnated repair material is stationary but can be exacerbated when the repair material is handled and moved into position within the damaged conduit. When resin redistribution occurs, fibers from the repair material become dislodged and flow with the resin creating a related problem of fiber redistribution.

As a result of resin and fiber redistribution, the material strength of the repair material is severely reduced. The reduction in the strength of the repair material affects the integrity of both the repair material and the damaged conduit. In addition, ineffective curing of the repair material results from resin and fiber redistribution, which further reduces the strength of the repair material.

Resin and fiber redistribution can occur in both vertical and horizontal segments of the repair material. For example, when the repair material is configured for the interface area between a main conduit and a lateral conduit, including the flange between the main and the conduit, resin and fiber redistribution can occur in all areas of the repair material. In some situations, resin and fiber redistribution can be extremely severe in vertical segments of the repair material because a greater amount of material is affected by gravitational forces. In the above example, a larger amount of resin and fiber redistribution can result in the area of the repair material corresponding to the flange area because the flange area is substantially vertical. Wherever resin and fiber redistribution occurs, the efficiency of the curing process and the strength of the repair material is reduced. Consequently, there is a definite need for a method to prevent resin and fiber redistribution in the repair material thereby ensuring the strength of the repair material and the efficiency of the curing process.

Conduits are often referred to as pipes, and include both the main and the lateral, which leads to the main. Typically, a lateral conduit originates at one location (i.e. a building or home) and terminates at another location within the main conduit. A lateral conduit can have either a vertical or horizontal orientation or run into the main conduit. Other conduits can be oriented predominately vertically.

In some situations, the lateral conduit has a linear configuration to the main conduit. These types of conduits are found in water treatment plants, chemical plants, and manufacturing facilities. Others can be embedded into the walls of buildings and structures for the conveyance of rainwater from a rooftop or gutter to a storm water system. However, in most situations, the lateral conduit delineates from a straight line and has at least one curved portion before reaching the main conduit.

In most prior CIPP applications, the repair material has been constructed from needled felts and as a result, the repair material was rigid. Rigid repair material cannot conform to the interior surface of non-linear conduits or to the interior surface of non-linear segments of a generally linear conduit. As a result, the repair material binds and wrinkles after the material is cured. The wrinkled repair material causes an obstruction that impedes and reduces flow of the material transported in the conduit. In addition, the exterior surface of the rigid repair material does not fully adhere to the interior surface of the non-linear conduit. As a result of the incomplete adherence to the interior surface, the strength of the finished repair material is reduced.

U.S. Pat. No. 5,606,997 to Blackmore discloses a method to cure repair material positioned in a damaged conduit. The repair material is formed by taking a generally flat sheet of material and manipulating it into a tubular structure with a seam. The resulting repair material is inflexible and the seam is an area of structural weakness. In addition, resin absorption and permeation is reduced in the seam area and as a result, the strength of the cured repair material is reduced. Curing of the rigid repair material is effectuated by resistively heating conductive materials that are positioned longitudinally within the repair material. The conductive materials are parallel strips of fiber bundles that extend lengthwise from a first end of the repair material to a second end. Because the conductive materials are arranged in a linear configuration, the problems associated with rigid repair materials apply. Accordingly, a need exists for a flexible repair material that can be used with non-linear conduits.

### SUMMARY OF THE INVENTION

The present invention provides a method for producing a repair material for use in repairing an interface area between two intersecting conduits, and a method and material for repairing a non-linear conduit.

According to one aspect of the invention, a mold is provided having similar dimensions to an interface area. The interface area is defined by a first conduit and a flange connecting the first conduit to a second conduit. A repair material is provided having a material structure, the material structure defined by an arrangement of fibers such that the material structure has similar dimensions to the interface area. The arrangement of fibers further allowing the repair material to be flexible and seamless.

A resin is provided, the resin having a resin viscosity. An additive is provided, the additive is adapted to increase the resin viscosity. The additive is mixed with the resin to form a resin-additive mixture whereby the resin viscosity is increased. The increased resin viscosity inhibits movement of the resin and thus reduces the likelihood of resin and fiber redistribution.

The repair material is placed in intimate contact with the mold. The mold includes a mold surface that supports the repair material. The resin-additive mixture is introduced into the repair material. A sufficient amount of time elapses for the resin-additive mixture to permeate the repair material such that the resin-additive mixture adheres to the fibers of the material thereby stabilizing the resin-additive mixture and the fibers. After the resin-additive mixture has fully adhered to and secured the fibers, the repair material is removed from the mold.

According to another aspect of the invention, a flexible membrane is placed over the repair material and the mold. A vacuum is then created between said the repair material and the mold and resin is introduced to the repair material. The vacuum facilitates introduction of the resin and holds the repair material in the desired shape against the mold's surface.

The present invention also provides a method of repairing a damaged section of a non-linear conduit. According to one aspect of the invention, a repair material is provided with a material structure adapted to engage an interior surface of a non-linear conduit. The material structure is defined by a plurality of fibers such that the repair material is flexible and seamless. A curable resin is introduced into the repair material by either injection or infusion depending on the type of resin utilized. Next, the repair material is placed in the conduit in close proximity to a damaged portion of the conduit. Lastly, the resin is cured. Curing can be achieved in a number of ways, including but not limited to using hot water, steam, resistive heating, or infrared and ultraviolet radiation.

Preferably, the material structure is cylindrical to facilitate conformity with the nonlinear conduit. However, other configurations, such as an octagon or decagon, are feasible provided that the dimensions for the alternative shapes closely match the interior dimensions of the damaged conduit. The material structure is flexible and can be formed by braiding the fibers. Because braided repair material is formed with its reinforcing fibers positioned helically rather than perpendicularly to the longitudinal axis of the structure, these fibers have the ability to change their braid angle and conform simultaneously to both the inside radius and outside radius of a section of a non-linear conduit. Consequently, repair materials fabricated by braiding offer an exceptional ability to conform to irregular conduit geometries.

The fibers can be electrically conductive fibers, for example carbon fibers. In order to cure the resin, an electric current can be caused to flow through the conductive fibers to resistively heat the repair material. Alternatively, the fibers can be a combination of electrically conductive fibers and non-conductive fibers, which include polyester, glass, aramid, and quartz fibers, and thermoplastic fibers such as, but not limited to, polypropylene, nylon and polyethylene.

According to another aspect of the invention, the seamless material structure is formed by knitting the fibers. In knitting, the repair material is produced by interlooping continuous chains of fibers in a circular fashion. Because the fibers are looped in a circular fashion at every stitch, the finished tubular structure is flexible and able to conform to irregular conduit geometries. Various reinforcing materials can also be included in the knit construction to accommodate both performance and cost issues. In addition, electrically conductive fibers can be used such that resistive heating is feasible to cure the resin.

According to another aspect of the invention, the seamless material structure is formed from a combination of two or more material layers. A first material layer is a cylindrical tube configured to fit within a second material layer that also has a cylindrical tube configuration. The first material layer is nested within the second material layer and then stitch-bonded together with a stitching thread to form the material structure. Stitch-bonding is a method by which different materials can be consolidated into various forms including seamless, tubular products. The consolidation results from either continuous or intermittent stitching or sewing through the various layers of materials. Again, electrically conductive fibers can be used such that resistive heating is feasible to cure the resin.

According to another aspect of the invention, the seamless material structure is formed from a combination of two or more material layers. A first material layer is a cylindrical tube configured to fit within a second material layer that also has a cylindrical tube configuration. The first material layer is nested within the second material layer and then needle-punched with a needle board to form the material structure. The needle board has a plurality of needles such that the needles penetrate the first material layer. When needles are driven through the first material layer, varying amounts of fibers from the first layer are pulled through the cross section of the adjacent second layer. These fibers effectively bind the first and second material layers together. In addition, electrically conductive fibers can be used such that resistive heating is feasible to cure the resin.

According to another aspect of the invention, an additive adapted to increase the curable resin viscosity is provided. The additive is mixed with the curable resin to form a resin-additive mixture whereby the resin viscosity is increased after a period of time has elapsed. The resin-additive adheres to the fibers in the first and second material layers. As a result, the resin-additive mixture stabilizes the fibers and the material layers. In addition, electrically conductive fibers can be used such that resistive heating is feasible to cure the resin.

Further aspects of the invention are disclosed in the detailed description of the preferred embodiment, the drawings and the claims.

### BRIEF DESCRIPTION OF THE DRAWINGS

Embodiments of the invention will be described with the aid of the following diagrammatic drawings:

FIG. 1 is a perspective view of a lateral conduit intersecting a main conduit;

FIG. 2 is a perspective view of the repair material configured for an interface area;

FIG. 3 is a cross-sectional view of a lateral conduit intersecting a main conduit;

FIG. 4 is a perspective view of a mold and repair material in accordance with one aspect of the present invention;

FIG. 5 is a cross-section of a repair material made in accordance with one aspect of the present invention;

FIG. 6 is another cross-section of a repair material made in accordance with one aspect of the present invention;

FIG. 7 is a repair material braided in accordance with one aspect of the present invention;

FIG. 8 is a repair material having a helical fiber arrangement made in accordance with one aspect of the present invention;

FIG. 9 is a cross-sectional view of a non-linear conduit having a predominantly vertical orientation in accordance with one aspect of the present invention; and,

FIG. 10 is a repair material knitted in accordance with one aspect of the present invention.

### DETAILED DESCRIPTION OF THE PREFERRED EMBODIMENT

While the invention is susceptible of embodiment in many different forms, there is shown in the drawings and will herein be described in detail preferred embodiments of the invention. It is to be understood that the present disclosure is to be considered as an exemplification of the principles of the invention. This disclosure is not intended to limit the broad aspects of the invention to the illustrated embodiments.

Repair Material for First and Second Conduit Interface:

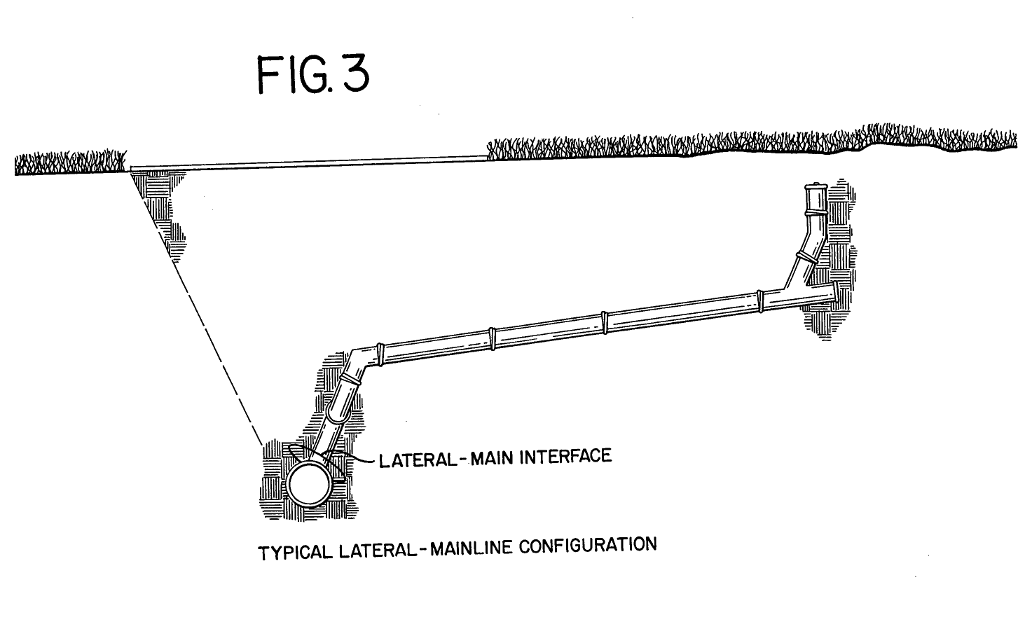

The present invention provides a method of producing a repair material for use in repairing an interface area between two intersecting conduits. The intersecting conduits shown for example in FIGS. 1 and 3 provide an area where the geometry of any repair material must be configured to match the otherwise generally cylindrical portions of the conduit. This more complex geometry increases the likelihood of resin and fiber redistribution during the repair process.

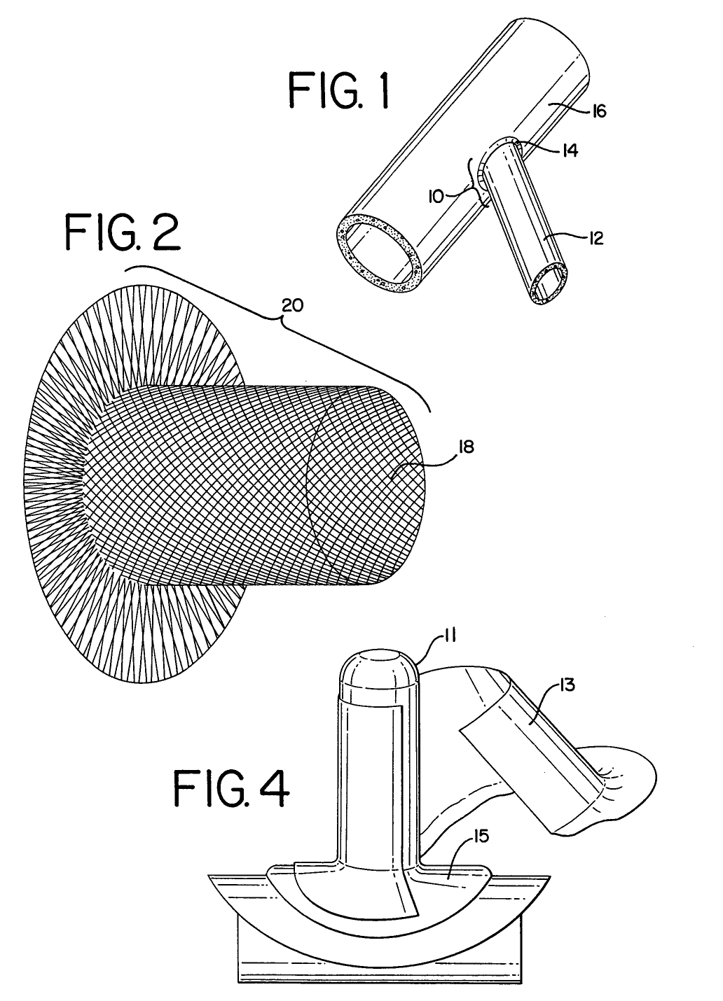

The method includes providing a mold 11 (shown in FIG. 4) having similar dimensions to an interface area 10, where the interface area 10 is defined by a first conduit 12 and a flange 14 connecting the first conduit 12 to a second conduit 16. The first conduit 12 can be either a main or a lateral conduit and the second conduit 16 can be either a lateral or a main conduit. Second, providing a repair material 18 (shown in one configuration in FIG. 2, and partially wrapped about the mold 11 in FIG. 4) having a material structure 20 configured to be inserted into the interface area 10. The material structure 20 is defined by an arrangement of fibers (not shown) such that the material structure 20 has similar dimensions to the interface area 10.

The mold 11 has a mold surface 15 capable of supporting the repair material 18. The fibers are arranged or commingled such that the repair material 18 is flexible and seamless. Specifically, the material structure 20 results from a seamless combination of fibers forming a cylindrical tube and flange configuration. Because the repair material 18 does not have a seam joining the cylindrical tube and the flange segments, there is no weakened area in the repair material 18. Consequently, the strength of the repair material 18 and the repaired portion of the conduit is not compromised.

Next, a resin having an initial resin viscosity is provided. This initial viscosity is typically low enough to allow the resin to be readily infused in the material structure 20. However, this low viscosity may also lead to the problems of resin and fiber redistribution, especially if there is a time delay between impregnating the material structure 20 with the resin, and placement and cure of the material at the interface area 10. The resin can be either a thermoset or thermoplastic variety. An additive is further provided that increases the resin viscosity, preferably after a time delay, as described below, to allow the resin to first permeate the material structure 20 before the increase in viscosity. The additive is formulated to increase the viscosity of the resin to a point where resin and fiber redistribution or flow cannot occur after the resin has been introduced into the repair material 18. The additive is mixed with the resin to form a resin-additive mixture. The viscosity increasing function can be controlled by varying the amount and chemistry of the additive.

The repair material 18 is placed in intimate contact with the mold 11 such that mold surface 15 supports the repair material 18. The resin-additive mixture is then introduced into the repair material 18. Depending upon the type of resin used, the introduction process can be either infusion or injection. The resin-additive mixture is allowed to wet-out or permeate the repair material 18 such that the resin-additive mixture adheres to the fibers. The additive must be carefully formulated to not initially increase the resin viscosity because this result would preclude permeation of the repair material 18. Preferably, the additive should begin to increase the resin viscosity after the repair material 18 is completely permeated with the mixture. Accordingly, a period of time should elapse between when the mixture is introduced into the repair material and when the additive has raised the viscosity of the resin. Depending upon the formulation of the additive, this period of time can vary between minutes to hours.

When the resin-additive mixture has fully permeated the fibers in the repair material 18, the resin-additive mixture and the fibers are secured and stabilized into a cohesive mass. After the resin-additive mixture has fully adhered to and secured the fibers, the repair material is removed from the mold 11.

In the repair material 18, the fibers can be knitted using a polar knitting process. This process allows for a change in geometry of the repair material 18 while maintaining the flexibility and integrity of the seamless repair material 18. These characteristics are especially important when the interface area 10 has irregular or complex shapes and surfaces. A variety of fibers, including carbon and aramid fibers, can be used in the polar knitting process. Additionally, thermoplastic fibers such as, but not limited to, polypropylene, nylon and polyethylene can be included in the repair material.

As an alternative to knitting, the fibers can be braided to form the seamless shape required to match the interface area 10. The helical arrangement of braided fibers provides excellent stiffness for the cured repair material 18 and allows a seamless transition from the cylindrical tube portion of the material to the radial flange portion.

Again, in addition to carbon and aramid fibers, the seamless repair material 18 can be formed from polyester fibers, glass fibers, or nylon fibers. The seamless repair material 18 can be formed from a combination of fibers, including but not limited to thermoplastic fibers and glass fibers.

Various types of resin can be used in this method, including but not limited to polyester resin, vinylester resin, urethane-polyester resin, urethane-vinylester resin, epoxy resin, and polyurethane resin. The additive must be formulated to timely increase the resin viscosity, and an example of a suitable additive is a combination of propoxylated bisphenol-A, diphenylmethane-diisocyanate, and dibutylin dilaurate catalyst.

In another preferred embodiment, a flexible membrane can be placed over the repair material 18 and the mold to create a vacuum between the membrane and the mold. This may facilitate introduction of the resin-additive mixture into the fibers of the repair material 18, and hold the material 18 in place during such introduction.

In another preferred embodiment, the mold has two portions. The first portion has a mold surface configured in either a male or female shape. The second portion has a corresponding mold surface configured in either a female or male shape (not shown). The repair material 18 is placed in intimate contact with the first mold portion. The second mold portion is then placed over the repair material 18 and the first mold portion to further secure the repair material 18. A flexible membrane can be placed over the mold portions and the repair material 18 to facilitate the creation of a vacuum.

In another preferred embodiment, a flexible film formed into a tubular configuration with an internal cavity is provided instead of the mold. The internal cavity is adapted to contain the repair material. After the resin-additive mixture is formed, the repair material is placed in the internal cavity of the flexible film. The resin-additive mixture is then introduced into the repair material and allowed to permeate the repair material. After the resin-additive mixture has fully adhered to and secured the fibers, the repair material is removed from the internal cavity. A flexible membrane can be used to create a vacuum. Instead of removing the repair material from the internal cavity, the repair material can remain in the internal cavity until time of use. This option requires an operator to transport the flexible film and repair material to the job-site and then remove the flexible film prior to installation of the repair material.

In another preferred embodiment, the present invention can be used to produce repair material for use in repairing any location of damaged conduit, not just the interface area between two intersecting conduits.

In another preferred embodiment, the resin-additive mixture is introduced into only a portion of the repair material 18. Introducing the mixture into only a portion of the repair material 18 is desirable when an extremely long segment of repair material 18 is used or when the additive is formulated from expensive components. When the repair material 18 has a material structure 20 with the cylindrical tube and flange configuration, the mixture can be introduced in only the flange segment to prevent resin and fiber redistribution in that area.

In another preferred embodiment, the repair material 18 can be produced while in the damaged conduit. The mold is inserted inside the conduit requiring repair and the repair material 18 is placed in intimate contact with the mold. A resin with a resin viscosity is provided. An additive formulated to increase the resin viscosity is also provided. The additive is mixed with the resin to form a resin-additive mixture which is then introduced into the repair material 18 while the repair material 18 and the mold are within the damaged conduit. The mixture is allowed to permeate the repair material 18 such that the mixture adheres to the fibers to form a cohesive mass. A conventional curing method is then utilized to cure the repair material 18. For example, an electric current can be applied to conductive fibers in the mold to resistively heat the mold and cure the repair materials.

Repairing Non-Linear Conduit:

The present invention also provides a method of repairing a damaged section of a non-linear conduit 110 such as that shown in FIG. 9. In this case, the non-linear conduit 110 is predominantly in a vertical orientation as part of building structure 112. The non-linear conduit 110 includes sections 114 that curve or bend, and thus do not follow a strictly linear path.

The method comprises providing a repair material 118 with a material structure adapted to engage a damaged section of an interior surface of a non-linear conduit 110. The material structure is defined by a plurality of fibers such that the repair material 118 is flexible and seamless. A flexible and seamless repair material is able to adapt and conform to of the interior surfaces of a non-linear conduit, especially the non-linear curved portions 114. Therefore, the repair material 118 will neither bind nor wrinkle to cause obstructions to material flow in the conduit.

Second, a curable resin is introduced into the repair material 118 by either injection or infusion depending on the type of resin utilized. The resin can be either thermoset or thermoplastic and more specifically could be a polyester resin, a vinylester resin, a urethane-polyester resin, a urethane-vinylester resin, an epoxy resin, or a polyurethane resin.

Next, the repair material is placed in the conduit in close proximity to a damaged portion of the conduit 110. Finally, the resin is cured. Curing can be achieved in a number of ways, including but not limited to using hot water, steam, resistive heating, or infrared and ultraviolet radiation.

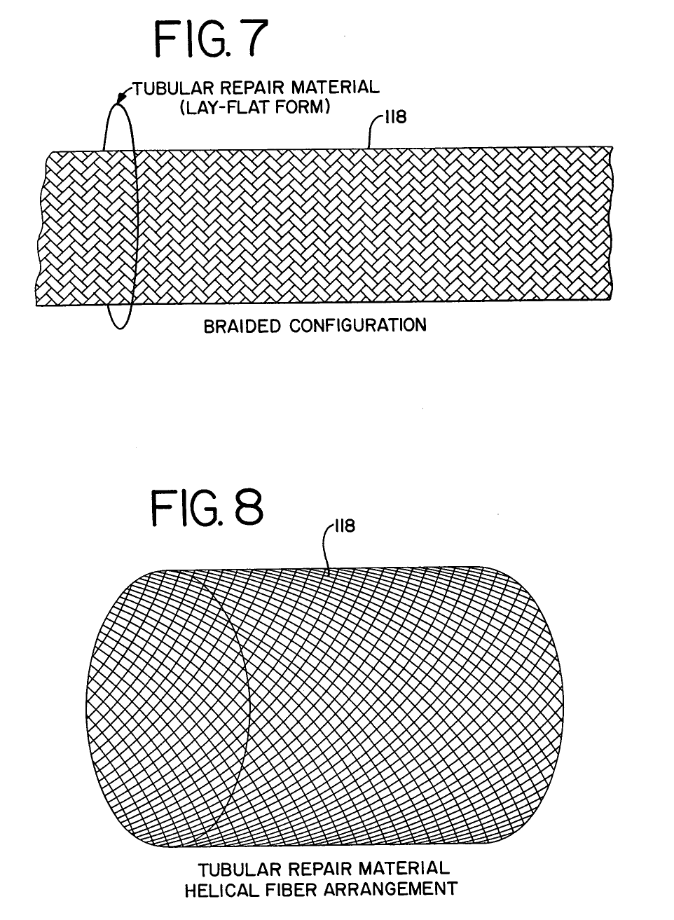

Preferably, the material structure 118 is substantially cylindrical (as shown in FIG. 8) to facilitate conformity with the non-linear conduit. However, the material structure is flexible and can be formed by braiding the fibers. A braided configuration is shown in FIG. 7. In braiding, most, if not all off the fibers are arranged in a helical pattern. However, triaxial braiding can be used to combine fibers at two different axial or helical angles with a non-helical, longitudinal fiber. Repair materials fabricated by braiding processes offer exceptional ability to conform to irregular conduit geometries. Because a braided repair material is formed with its reinforcing fibers positioned helically rather than perpendicularly to the longitudinal axis of the material structure, these fibers have the ability to change their braid angle, and conform simultaneously to both the inside radius and outside radius of a section of a non-linear conduit.

Depending on the desired mechanical properties, the density of the fiber braid can be varied to pack more fibers into the tubular arrangement to provide an increase in strength. Conversely, if the structural requirements are minimal, the braid density can be adjusted to where the material present in a volumetric area can be reduced. The angle at which the fibers intersect each other, otherwise known as the braid angle, can also be varied. When the braid angle is increased, the fibers are positioned closer to perpendicular or vertical and the hoop strength of the finished repair material increases. This is desirable for conduits that are required to support a great amount of weight or withstand high internal pressures. Various reinforcing materials can also be included in the braided construction to accommodate both performance and cost issues.

Additionally, the fibers can be electrically conductive fibers, for example carbon fibers. In order to cure the resin, an electric current can be caused to flow through the conductive fibers to resistively heat the repair material. Alternatively, the fibers can be a combination of electrically conductive fibers and non-conductive fibers, which include polyester, glass, aramid, and quartz fibers, and thermoplastic fibers.

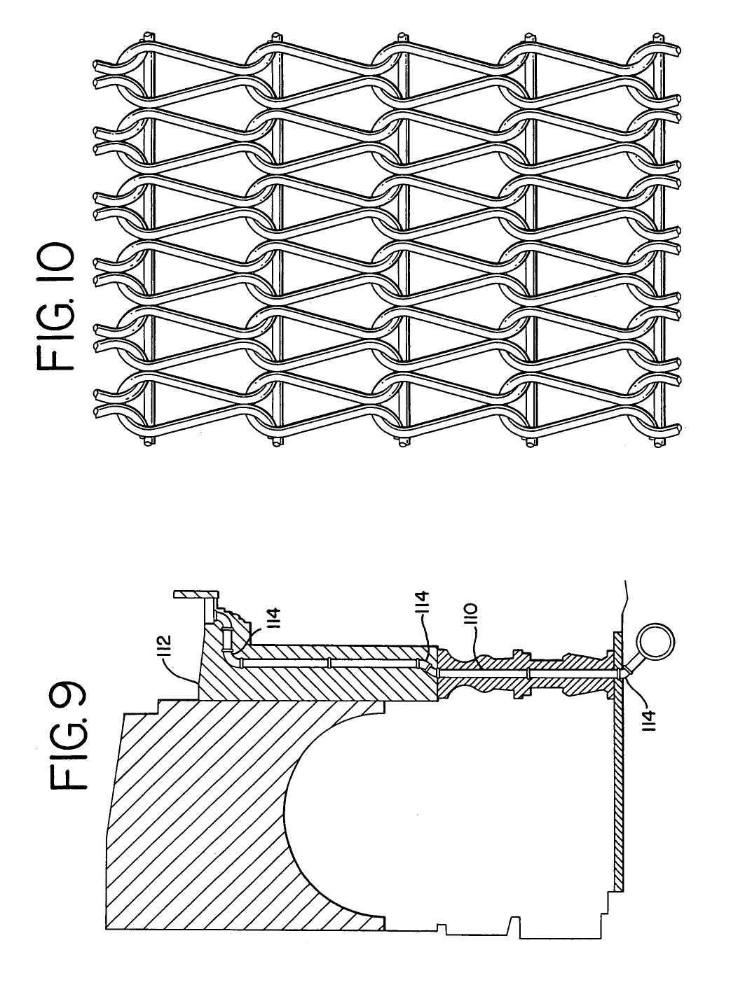

In another preferred embodiment, the electrically conductive fibers have an exterior layer or coating of electrically non-conductive material. The non-conductive material is adapted to insulate the electrically conductive fibers that are then braided. In another preferred embodiment, the seamless material structure 118 is formed by knitting the fibers. In knitting, the repair material is produced by interlooping continuous chains of fibers in a circular fashion. An enlarged view of knitted fibers is shown in FIG. 10. In a rochelle knit, it is possible to introduce the fibers in a basically longitudinal direction. Because the fibers are looped in a circular fashion at every stitch, the finished tubular structure is inherently flexible. For example, in one linear inch of fiber stitch, the actual fiber length may be as long as two inches. This allows continuity in the fibers throughout the length as well as allowing the fiber loops to stretch or open up to variances in the conduit geometry. Various reinforcing materials can also be included in the knit construction to accommodate both performance and cost issues. In addition, electrically conductive fibers can be used such that resistive heating is feasible to cure the resin.

In another preferred embodiment, the seamless material structure is formed from a combination of two or more material layers. A first material layer is a seamless, cylindrical tube configured to fit within a second material layer that has a seamless, cylindrical tube configuration. The material layers are formed from an arrangement of fibers, preferably either braided or knitted fibers. The first material layer is nested within the second material layer and then stitch-bonded together with a stitching thread to form the material structure. Preferably, the stitching thread is elastic to further ensure flexibility of the repair material. In addition, electrically conductive fibers can be used such that resistive heating is feasible to cure the resin.

Stitch-bonding is a method by which different materials can be consolidated into various forms including seamless, tubular products. The consolidation results from either continuous or intermittent stitching or sewing through the various layers of materials. Reinforcing fibers can be used and aligned in a helical arrangement to accommodate geometry changes much like a braided composite. Stitch-bonding also allows the use of a wider variety of electrically conductive material formats such as non-woven graphite formed into tapes. These tapes would be introduced into the composite at a helical angle.

In another preferred embodiment, the seamless material structure is formed from a combination of two or more material layers. A first material layer is a seamless, cylindrical tube configured to fit within a second material layer that also has a seamless, cylindrical tube configuration. The material layers are formed from an arrangement of fibers, preferably either braided or knitted fibers. The first material layer is nested within the second material layer and then needle-punched with a needle board to form the material structure. The needle board has a plurality of needles such that the needles penetrate the first material layer. When needles are driven through the first material layer, varying amounts of fibers from the first material layer are pulled through the cross section of the adjacent second material layer. These fibers effectively bind the material layers together. In addition to consolidation, the fibers also provide reinforcement in the Z axis, defined as the axis corresponding to the material layer thickness. The characteristics of the repair material, including flexibility, can be altered by varying the force applied to the needle board, the type and number of needles used, and the number of needle penetrations per square inch. In addition, electrically conductive fibers can be used such that resistive heating is feasible to cure the resin.

In another preferred embodiment, an additive adapted to increase the resin viscosity is provided. The additive is mixed with the resin to form a resin-additive mixture whereby the resin viscosity is increased after a period of time has elapsed. The additive should be formulated such that the resin viscosity does not immediately increase because this could preclude either resin introduction or resin permeation of the repair material. The resin-additive adheres to the fibers in the first and second material layers. As a result, the resin-additive mixture stabilizes the fibers and the material layers. In addition, electrically conductive fibers can be used such that resistive heating is feasible to cure the resin.

In another preferred embodiment, thermoplastic fibers 124 are used in conjunction with other reinforcing fibers to form the material structure 118. These fibers can be one of a combination of various engineered thermoplastics. In addition, thermoplastic films 130 may be used. These fibers, films and reinforcing fibers can be consolidated using any of the aforementioned methods. Various non-electrically conductive fibers can be employed as reinforcement. When electrically conductive fibers are used in conjunction with the thermoplastic fibers and films, resistive heating can be used to generate heat. The heat generated causes the thermoplastic materials to melt and flow, permeating the electrically conductive fibers and other non-electrically conductive fibers. A reinforced thermoplastic composite results when the materials cool and harden. In this embodiment, the need for liquid resins is eliminated offering unlimited shelf life and ease of handling. Finished composite properties can be customized with the selection of an appropriate thermoplastic matrix and reinforcing fibers.

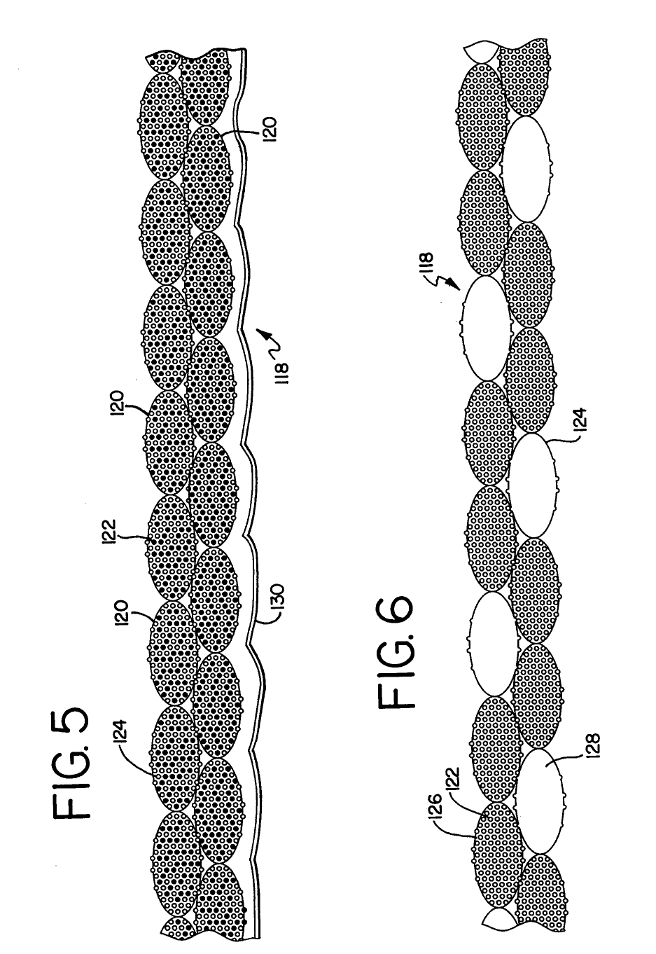

As shown in cross-section in FIGS. 5, the fibers can be in bundles 120 having both electrically conductive fibers 122 and thermoplastic fibers 124. Additionally, FIG. 5 also shows a film 130 of thermoplastic material that forms part of the material structure 118. Alternatively, separate bundles 126 of electrically conductive fibers 122 can be comingled with bundles 128 of thermoplastic fibers 124, as shown in FIG. 6. In both cases, the bundles may be braided together to form, the repair material 118.

While specific embodiments have been illustrated and described, numerous modifications are possible without departing from the spirit of the invention, and the scope of protection is only limited by the scope of the accompanying claims.

We claim:

1. A method of producing a repair material for use in repairing an interface area between two intersecting conduits, comprising the steps of:
providing a mold having similar dimensions to an interface area, the interface area defined by a first conduit and a flange connecting the first conduit to a second conduit, the mold having a mold surface;
providing a repair material having a material structure, the material structure defined by an arrangement of fibers such that the material structure has similar dimensions to the interface area, the arrangement of fibers further allowing the repair material to be flexible;
providing a resin, the resin having a resin viscosity;
providing an additive adapted to increase the resin viscosity;
mixing the additive with the resin to form a resin-additive mixture whereby the resin viscosity is increased;
placing the repair material in intimate contact with the mold such that mold surface supports the repair material;
introducing the resin-additive mixture into the repair material;
allowing the resin-additive mixture to permeate the repair material such that the resin-additive mixture adheres to the fibers thereby stabilizing the resin-additive mixture and the fibers; and,
removing the repair material from the mold after the resin-additive mixture has fully adhered to and secured the fibers.

2. The method of claim 1 further comprising the steps of:
placing a flexible membrane over the repair material and the mold;
creating a vacuum between said the repair material and the mold.

3. The method of claim 1 wherein the step of providing a repair material having a material structure comprises the step of braiding said fibers.

4. The method of claim 1 wherein the step of providing a repair material having a material structure comprises the step of knitting said fibers.

5. The method of claim 1 wherein the step of providing a repair material, the fibers are polyester fibers.

6. The method of claim 1 wherein the step of providing a repair material, the fibers are glass fibers.

7. The method of claim 1 wherein the step of providing a repair material, the fibers are nylon fibers.

8. The method of claim 1 wherein the step of providing a repair material, the fibers are aramid fibers.

9. The method of claim 1 wherein the step of providing a repair material, the fibers are carbon fibers.

10. The method of claim 1 wherein the step of providing a repair material, the fibers are a combination of thermoplastic fibers and glass fibers.

11. The method of claim 1 wherein the step of providing a resin, the resin is a polyester resin.

12. The method of claim 1 wherein the step of providing a resin, the resin is a vinylester resin.

13. The method of claim 1 wherein the step of providing a resin, the resin is a urethane-polyester resin.

14. The method of claim 1 wherein the step of providing a resin, the resin is a urethane-vinylester resin.

15. The method of claim 1 wherein the step of providing a resin, the resin is an epoxy resin.

16. The method of claim 1 wherein the step of providing a resin, the resin is a polyurethane resin.

17. The method of claim 1 wherein the step of providing an additive, the additive is a combination of propoxylated bisphenol-A, diphenylmethane-diisocyanate, and dibutylin dilaurate catalyst.

18. A method of producing a repair material for use in repairing an interface area between two intersecting conduits, comprising the steps of:
providing a repair material having a material structure, the material structure defined by an arrangement of fibers such that the material structure has similar dimensions to the interface area, the arrangement of fibers further allowing the repair material to be flexible and seamless;
providing a flexible film formed into a tubular configuration with an internal cavity adapted to contain the repair material;
providing a resin, the resin having a resin viscosity;
providing an additive adapted to increase the resin viscosity;
mixing the additive with the resin to form a resin-additive mixture whereby the resin viscosity is increased;
placing the repair material into the internal cavity of the flexible film;
introducing the resin-additive mixture into the repair material allowing the resin-additive mixture to permeate the repair material such that the resin-additive mixture adheres to the fibers thereby stabilizing the resin-additive mixture and the fibers; and,
removing the repair material from the flexible film after the resin-additive mixture has fully adhered to and secured the fibers.

19. The method of claim 18 further comprising the steps of:
creating a vacuum within said flexible film.

20. The method of claim 18 wherein the repair material remains in the flexible film envelope until time of use.

21. A method of producing a repair material for use in repairing an interface area between two intersecting conduits, comprising the steps of:
providing a mold having similar dimensions to an interface area, the interface area defined by a first conduit and a flange connecting the first conduit to a second conduit, the mold having a mold surface;
providing a repair material having a material structure, the material structure defined by an arrangement of fibers such that the material structure has similar dimensions to the interface area, the arrangement of fibers further allowing the repair material to be flexible and seamless;
providing a resin, the resin having a resin viscosity;
providing an additive adapted to increase the resin viscosity after an amount of time has elapsed;
mixing the additive with the resin to form a resin-additive mixture;
placing the repair material in intimate contact with the mold such that mold surface supports the repair material;
introducing the resin-additive mixture into the repair material;
allowing the viscosity of the resin in the resin-additive mixture to increase;
further allowing the resin-additive mixture to permeate the repair material such that the resin-additive mixture adheres to the fibers thereby stabilizing the resin-additive mixture and the fibers; and,
removing the repair material from the mold after the resin-additive mixture has fully adhered to and secured the fibers.

22. A method of producing a repair material for use in repairing a damaged conduit, comprising the steps of:
providing a mold having similar dimensions to an interior area of a damaged conduit;
providing a repair material having a material structure, the material structure defined by an arrangement of fibers such that the material structure has similar dimensions to the interior area, the arrangement of fibers further allowing the repair material to be flexible and seamless;
providing a resin, the resin having a resin viscosity;
providing an additive adapted to increase the resin viscosity after an amount of time has elapsed;
mixing the additive with the resin to form a resin-additive mixture;
placing the mold in the damaged conduit;
placing the repair material in intimate contact with the mold such that mold surface supports the repair material;
introducing the resin-additive mixture into the repair material;
allowing the viscosity of the resin in the resin-additive mixture to increase;
further allowing the resin-additive mixture to permeate the repair material such that the resin-additive mixture adheres to the fibers thereby stabilizing the resin-additive mixture and the fibers;
curing the repair material such that the resin undergoes a phase change; and,
removing the mold from the interior area of the conduit.

23. The method of claim 22 wherein the step of curing the repair material is performed by using steam to cure the repair material.

24. The method of claim 22 wherein the step of curing the repair material is performed by using hot water to cure the repair material.

25. The method of claim 22 wherein the step of curing the repair material is performed by applying an electric current to a plurality of electrically conductive fibers in the mold to resistively heat the mold and the repair material.

26. A method of producing a conduit repair material comprising
forming a plurality of fibers into a structure having appropriate dimensions for repair of at least a portion of a conduit;
providing a resin having a resin viscosity;
introducing a time delayed additive to said resin for increasing the viscosity of said resin after a period of time after introduction with said resin; and,
introducing said resin and additive to said structure.

27. The method of claim 26 further comprising placing said structure in a conduit and curing said resin and additive mixture.

28. A method of repairing a damaged section of a non-linear conduit, comprising the steps of:
providing a repair material having a material structure adapted to engage an interior surface of a non-linear conduit, the material structure defined by a plurality of fibers such that the repair material is flexible and seamless;
introducing a curable resin into the repair material;
placing the repair material in the conduit in close proximity to a damaged portion of the non-linear conduit; and,
curing the resin in the repair material.

29. The method of claim 28 wherein the step of providing a repair material comprises braiding said fibers to form a substantially cylindrical material structure.

30. The method of claim 29 wherein said fibers are electrically conductive fibers.

31. The method of claim 30 further comprising the step of causing an electric current to flow through the conductive fibers to resistively heat the repair material to cure the resin.

32. The method of claim 29 wherein the fibers are a combination of electrically conductive fibers and non-conductive fibers.

33. The method of claim 32 further comprising the step of causing an electric current to flow through the conductive fibers to resistively heat the repair material to cure the resin.

34. The method of claim 28 wherein the step of providing a repair material comprises knitting said fibers to form a substantially cylindrical material structure.

35. The method of claim 34 wherein the fibers are electrically conductive fibers.

36. The method of claim 35 further comprising the step of causing an electric current to flow through the conductive fibers to resistively heat the repair material to cure the resin.

37. The method of claim 34 wherein the fibers are a combination of electrically conductive fibers and non-conductive fibers.

38. The method of claim 28 wherein said non-linear conduit is predominantly vertical in orientation.

39. A method of repairing a damaged section of a non-linear conduit, comprising the steps of:
providing a repair material having a material structure adapted to engage an interior surface of a non-linear conduit, the material structure defined by a plurality of electrically conductive fibers such that the repair material is flexible and seamless, the electrically conductive fibers having an exterior layer of electrically non-conductive material adapted to insulate the electrically conductive fibers;
introducing a curable resin into the repair material;
placing the repair material in the conduit in close proximity to a damaged section of the non-linear conduit; and,
curing the resin in the repair material.

40. The method of claim 39 wherein the step of providing a repair material comprises braiding said fibers to form a substantially cylindrical material structure.

41. The method of claim 40 further comprising the step of causing an electric current to flow through the electrically conductive fibers to resistively heat the repair material to cure the resin.

42. The method of claim 39 wherein the step of providing a repair material comprises knitting said fibers to form a substantially cylindrical material structure.

43. The method of claim 39 wherein said non-linear conduit is predominantly vertical in orientation.

44. A method of repairing a damaged section of a non-linear conduit, comprising the steps of:
providing a repair material having a material structure adapted to engage an interior surface of a non-linear conduit, the material structure formed from a combination of a first material layer and a second material layer, the material layers defined by a plurality of fibers such that the repair material is flexible and seamless;
introducing a curable resin into the repair material;
placing the repair material in the conduit in close proximity to a damaged section of the non-linear conduit; and,
curing the resin in the repair material.

45. The method of claim 44 wherein the step of providing a repair material comprises stitch-bonding the material layers with an elastic stitching thread to form the material structure in a substantially cylindrical configuration.

46. The method of claim 45 wherein the fibers are electrically conductive fibers.

47. The method of claim 46 further comprising the step of causing an electric current to flow through the conductive fibers to resistively heat the repair material to cure the resin.

48. The method of claim 45 wherein the fibers are a combination of electrically conductive fibers and non-conductive fibers.

49. The method of claim 44 wherein said non-linear conduit is predominantly vertical in orientation.

50. The method of claim 44 wherein the step of providing a repair material comprises needle-punching said material layers with a needle board to form the material structure in a substantially cylindrical configuration, the needle board having a plurality of needles such that the needles penetrate the first material layer driving a portion of the fibers from the first material layer into contact with the second layer to support the second layer.

51. The method of claim 48 further comprising the step of causing an electric current to flow through the conductive fibers to resistively heat the repair material to cure the resin.

52. A method of repairing a damaged section of a non-linear conduit, comprising the steps of:
providing a repair material having a material structure adapted to engage an interior surface of a non-linear conduit, the material structure formed from a combination of a first material layer and a second material layer, the material layers defined by a plurality of fibers such that the repair material is flexible and seamless;
providing a resin, the resin having a resin viscosity;
providing an additive adapted to increase the resin viscosity;
mixing the additive with the resin to form a resin-additive mixture whereby the resin viscosity is increased;
introducing the resin-additive mixture into the repair material;
allowing the resin-additive mixture to permeate the repair material;
further allowing the resin-additive mixture to adhere to the fibers thereby stabilizing the resin-additive mixture, the fibers, and the material layers;
placing the repair material in the conduit in close proximity to a damaged section of the non-linear conduit; and,
curing the resin-additive mixture in the repair material.

53. The method of claim 52 wherein the fibers are electrically conductive fibers.

54. The method of claim 53 further comprising the step of causing an electric current to flow through the conductive fibers to resistively heat the repair material to cure the resin.

55. The method of claim 52 wherein the fibers are a combination of electrically conductive fibers and non-conductive fibers.

56. The method of claim 55 further comprising the step of causing an electric current to flow through the conductive fibers to resistively heat the repair material to cure the resin.

57. The method of claim 52 wherein the non-linear conduit is predominantly vertical in orientation.

58. A method of repairing a damaged section of a non-linear conduit comprising the steps:
providing a repair material having a flexible material structure adapted to engage an interior surface of a non-linear conduit, the material structure comprising a plurality of thermoplastic fibers;
positioning said repair material proximate a section of said non-linear conduit;
providing heat to said repair material, causing said thermoplastic fibers to melt and flow; and,
cooling said repair material to cause said melted thermoplastic fibers to harden.

59. The method of claim 58 further comprising providing said repair material with non-thermoplastic non-conductive fibers.

60. The method of claim 58 further comprising providing said repair material with electrically conductive fibers.

61. The method of claim 60 further comprising resistively heating said electrically conductive fibers to provide said heat to said repair material.

62. The method of claim 60 further comprising braiding said electrically conductive fibers.

63. The method of claim 60 further comprising knitting said electrically conductive fibers.

64. The method of claim 58 wherein said non-linear conduit is predominantly vertical in position.
